(19) United States
(12) Patent Application Publication
(10) Pub. No.: US 2011/0054906 A1
(43) Pub. Date: Mar. 3, 2011

(54) Multimedia Keepsake with Customizable Content

(75) Inventor: Geoffrey S. Stern, Westport, CT (US)

(73) Assignee: TALKING PIX SYSTEMS LLC, Westport, CT (US)

(21) Appl. No.: 12/933,957

(22) PCT Filed: Apr. 16, 2009
(86) PCT No.: PCT/US2009/040781

§ 371 Date: Nov. 5, 2010

Related U.S. Application Data
(60) Provisional application No. 61/045,720, filed on Apr. 17, 2008.

(51) Int. Cl. G10L 21/00

(52) U.S. Cl. 704/272

(57) ABSTRACT

a multimedia playback keepsake and a method for its production are provided. The keepsake includes a control processor and a playback processor. The control processor is associated with storage containing a content program to be presented and contains interrupts corresponding to points in the content program where custom content information is to be presented. The playback processor contains content elements associated with the interrupts. The content program is presented to the playback processor for play back and, when an interrupt is encountered, the control processor causes the playback processor to insert and playback the appropriate content element. As a result a content program is provided which includes custom inserts at the interrupts.

### BACKGROUND OF THE INVENTION

The present invention relates generally to multimedia keepsakes, and more particularly, concerns a recordable, multimedia playback apparatus in which the content may be customized.

In International Application No. PCT/U.S. 08/63717, under common ownership with the present application, there are disclosed multimedia keepsakes, in the form of multimedia greetings and albums, in which playable multimedia content is provided in electronic storage. When the keepsake is a greeting, such as a card, the amount of storage required for the multimedia content is relatively small, and inexpensive electronics may be used. When the keepsake is a multimedia album, such as one with images, music and voice recordings, the expense of the album justifies the expense of more complex electronics. In either case, custom content can be recorded, while still permitting the keepsake to sell at a price point appropriate for the particular item.

However, it would be desirable to be able to provide a relatively large amount of multimedia content at a relatively low price point, while still permitting customization of content. For example, one might wish to provide a full length storybook for a child, while permitting the names of characters, their ages or where they live to be customized Doing so, for example, by providing for customized recording of the storybook becomes infeasible if a low price point is to be met, because of the expense of recordable electronics with a sufficient storage capacity for the entire storybook.

### SUMMARY OF THE INVENTION

In accordance with the present invention, a multimedia keepsake and a method for its production are provided.

In accordance with one aspect of the invention, the keepsake includes a first information storage containing fixed program information corresponding to a primary content presentation, the content presentation having gaps, and a second information storage containing variable information. A controller is provided which includes an indexing module associating the variable information with the gaps, an assembling module playing the fixed program information from the first information storage and cooperating with said indexing module to insert the variable information into associated gaps to produce a customized content presentation.

In accordance with one aspect of the invention, the keepsake includes a control processor and a playback processor. The control processor is associated with storage containing a content program to be presented. The control processor has programmed interrupts corresponding to points in the content program where custom information is to be presented, and the playback processor contains content elements associated with the interrupts. The content program is presented to the playback processor for play back. When an interrupt is encountered, the control processor causes the playback processor to insert and playback the appropriate content element. As a result a content program is provided which includes custom inserts at the interrupts.

In a preferred embodiment, the keepsake plays a customized audio storybook. The control processor is an audio synthesis processor and contains the storybook in a read only memory (ROM). The audio synthesis processor synthesizes an audio signal and provides it to a record/playback, which causes it to be played. The story saved in the synthesis processor has interrupts at locations where custom information is to be inserted. Custom audio information is recorded in the playback processor. After programming, upon the occurrence of an interrupt, the synthesis processor controls the playback processor so as to play the appropriate custom information. As a result, the two processors cooperatively produce a complete story, with customized content.

In accordance with one aspect of the present invention, the playback processor is programmed with externally provided content elements in cooperation with the control processor. Each provided content element includes information identifying the corresponding interrupt. The control processor causes this information to be stored in the playback processor in association with an identification of the interrupt. Thus, when an interrupt is later encountered, the control processor can cause the playback processor to produce the correct content element.

### BRIEF DESCRIPTION OF THE DRAWINGS

the foregoing brief description and further objects, features and advantages of the present invention will be understood more completely from the following detailed description of presently preferred, but nonetheless illustrative, embodiments in accordance with the present invention, with reference being had to the accompanying drawings in which:

FIG. 1 is a functional block diagram illustrating a device embodying a multimedia keepsake in accordance with the present invention, in the form of an electronic storybook;

FIG. 2 is a schematic diagram of a preferred embodiment of Detection Circuit 14 of FIG. 1;

FIG. 3 is a schematic diagram illustrating a preferred record/playback processor for use in an embodiment in accordance with the present invention; and

FIG. 4 is a functional block diagram of a preferred integrated circuit useful as Audio Synthesis Processor 18 in FIG. 1.

### DETAILED DESCRIPTION OF THE PREFERRED EMBODIMENTS

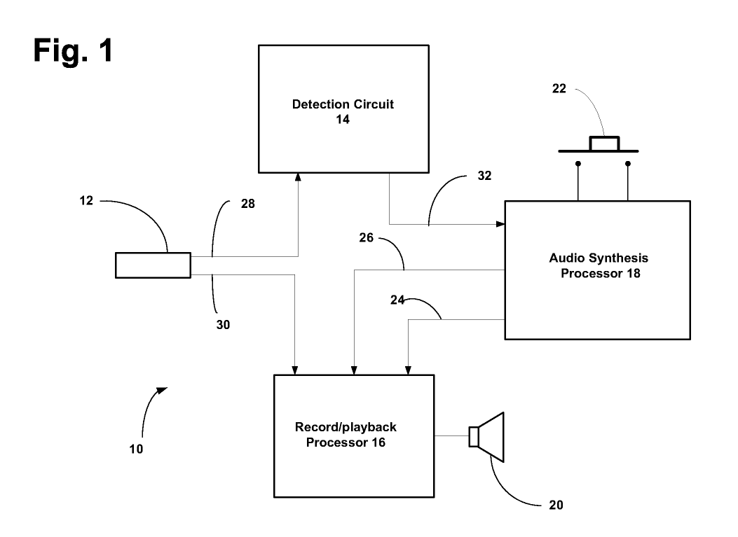

Turning now to the details of the drawings, FIG. 1 is a functional block diagram illustrating a device 10 embodying a multimedia keepsake in accordance with the present invention, in the form of an electronic storybook 10. The storybook plays an audible story, for example a fairy tale, which is customized for the listener. For example, the name of a character in the story may be the same as the listener's, the age may be the same, the town he lives in may be the same, or the names of his brothers and sisters may be the same.

Preferably, the device 10 is on a small circuit card, which may also include batteries (not shown). The card may, for example, be embedded in the covers of a physical book which has accompanying pictures and text. Device 10 is shown as including a pushbutton 22. In practice, this button may be on the book cover and electrically coupled to device 10. The purpose of the button is to trigger playback of the story when the reader presses it. Playback may, for example, be in sections, with the button having to be pressed again after a section plays.

Device 10 comprises a stereo jack 12, a Detection Circuit 14, a Record/playback Processor 16 and an Audio Synthesis Processor 18. A customized audio program is heard via a speaker 20, driven by processor 16. The storybook is stored in a read only memory (ROM) in processor 18. Processor 18 synthesizes an audio signal and provides it to processor 16 via lead 24, and processor 16 provides the audio signal to speaker 20. The story saved in processor 18 has interrupts at locations where custom information is to be inserted. As will be explained in detail below, custom audio information is recorded in processor 16, in coordination with processor 18. After programming as will be described below, upon the occurrence of an interrupt, processor 18 controls processor 16, via lead 26 (it may contain multiple leads or channels and be bidirectional), so as to play the appropriate custom information. As a result, the two processors cooperatively produce a complete story, with customized content.

Jack 12 is a conventional stereo jack. As will be explained below, one of the stereo channels, for example on lead 28, is an audio control signal and the other, for example on lead 30, contains audio information. Detection Circuit 14 responds to the control signal, informing processor 18 which audio information is currently being received and stored in processor 16. For example, there may be four pieces of custom audio information stored in processor 16 in predetermined locations. Detection Circuit 14 informs processor 18 as each piece is stored and signals the duration of each piece. Subsequently, when processor 18 experiences an interrupt, it informs processor 16 of the appropriate piece of information to insert and pauses for the appropriate length of time.

Although device 10 has been described as making use of a jack 12, those skilled in the art will appreciate that other types of connectors can serve equally well. For example, it is contemplated that a USB connector, which has by now become ubiquitous, could be used instead.

It is contemplated that audio information to be inserted into processor 16 could conveniently be generated online, at a website set up for that purpose, which would produce the necessary control information. When a user wishes to program device 10, he need merely access the website and connect a stereo cable between his computer and jack 12. At the website, he would have a selection of information to insert at each interrupt, or he could be offered the opportunity to type in his own. He could also be permitted to record his voice speaking the information. Preferably, the downloaded files would have the audio information in the same voice as the story itself. Of course, this process could also be performed at a kiosk, for example at a retail establishment, or software could be provided to perform the task on a home computer. Similarly, the required two channel signal could be recorded in an electrical device, such an MP3 player or a telephone, and then transferred from the electrical device to processor 16.

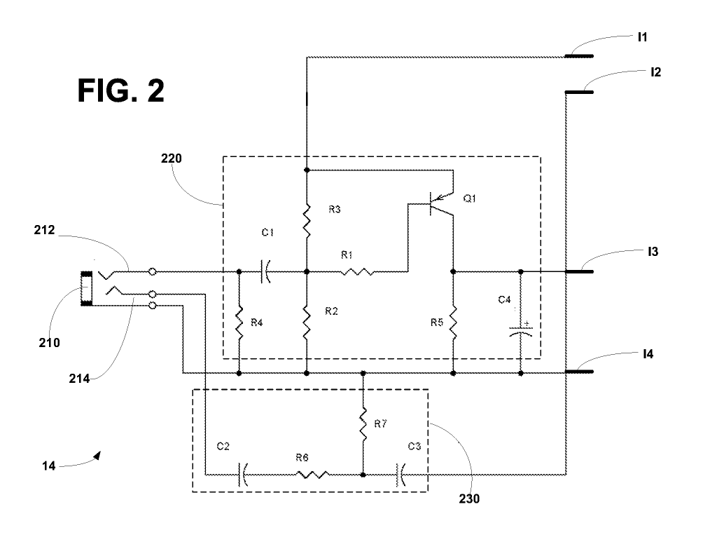

FIG. 2 is a schematic diagram of a preferred embodiment of Detection Circuit 14. In this embodiment, circuit 14 has a stereo jack 210, which replaces jack 12 in FIG. 1. As explained above a conventional stereo plug providing a stereo signal is inserted into this jack. In this example, the tip 212 of the stereo plug carries the channel with the control information and the ring 214 of the plug carries the audio recording. The control signal is preferably a tone of a predetermined frequency, and the duration of the tone preferably determines which piece of information is being sent. The tone signal is received by a tone detector 220, which is constructed to be sensitive to the frequency of the tone. This produces a voltage between connections I3 and I4 which indicates the presence of the tone. That voltage is present while the tone is present, and the duration of the tone tells processor 14 which piece of information is being recorded. The audio signal at the ring 214 is applied to connection 12 through a filter 230, and connection 12 is connected to a microphone input on processor 16.

Although the duration of the tone preferably identifies which piece of information is being received. It will be appreciated that the received signal could simply include a field specifying the number of pieces of information being sent, and the piece of information being sent at any time could simply be established from the sequence. Alternately, the tone burst corresponding to each piece of information could be coded to identify the piece of information. For example, the tone burst could be amplitude modulated to represent a series of 1 and 0 digits that encode the piece of information.

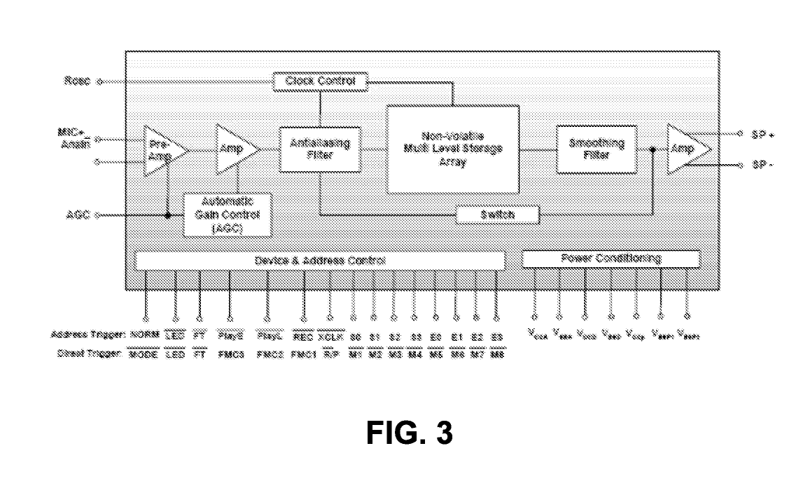

Record/playback Processor 16 is preferably an ISD14B20 ChipCorder® available from Windbond Electronics Corporation America of San Jose, Calif. The device is a multiple message, single chip, record/playback circuit. It is a CMOS device which includes an on-chip oscillator, microphone preamplifier, automatic gain control, anti-aliasing filter, a solid-state analog storage array, a smoothing filter, and a speaker amplifier. Address inputs are provided, which permit selection of different recordings. A functional schematic diagram of this chip is shown in FIG. 3.

As seen in FIG. 3, negative and positive inputs are provided for differential connection of a microphone or a microphone and a reference. It is also possible to provide to an analog line signal between these two inputs, in this case the signal on lead 30. The applied signal is subjected to automatic gain control (AGC) and is then applied to a nonvolatile multilevel storage array through an anti-aliasing filter. In this array, the signals are stored in analog form. A signal stored in the array is processed by a smoothing filter before being amplified, to produce a speaker drive signal between the outputs SP+ and SP−. Applied power supply voltages are subjected to power condition, and control inputs are available for recording (REC) and two types of playback, edge-triggered playback (PLAYE) and level-triggered playback (PLAYL), as well as addressing internal memory (M1-M8).

The integrated circuit is comprised of flash memory cells, so messages can be stored without the use of power. Since storage is analog, audio data can be stored directly and memory in its natural form, without a compression, as is the case with digital audio. This provides high-quality, solid-state audio reproduction, with a minimum power consumption.

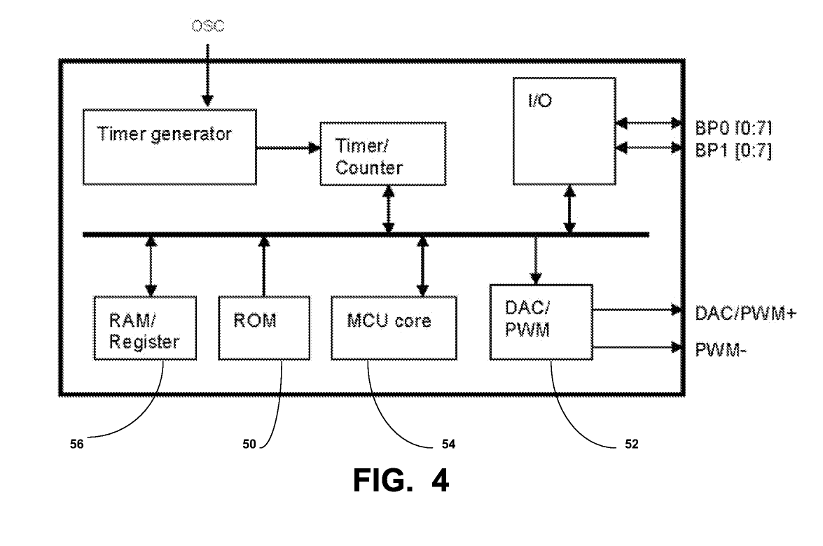

Audio Synthesis Processor 18 is preferably a W588CXX embedded, single chip microprocessor available from Windbond Electronics Corporation America of San Jose, Calif. The “XXX” relates to number, such as “150” which defines the duration of a recorded signal. FIG. 4 is a functional block diagram of the W588C chip. It includes a ROM 50, in which the story may be recorded. A digital-to-analog converter (DAC) 52 then makes it possible to produce analog audio signal, which may be provided to processor 16. Also included are a microprocessor core 54 and random access memory 56, which permit extensive programming, including interrupt processing. Two bi-directional, eight bit ports BP0 and BP 1 provide communication with processor 16.

Although preferred embodiments of the invention have been disclosed for illustrative purposes, those skilled in the art will appreciate that many additions, substitutions, and modifications are possible without departing from the scope and spirit of the invention. For example, the preferred embodiment creates a custom audio storybook. Those skilled in the art will appreciate that a customized multimedia story book, such as on including audio and visible content, could be produced with similar structure and in a similar manner.

What is claimed:

1. A multimedia keepsake providing a customized content presentation, comprising:
first information storage containing fixed information corresponding to a primary content presentation, the content presentation having gaps;
second information storage containing variable information; and
control means including:
an indexing module associating the variable information with said gaps;
an assembling module playing the fixed information from said first information storage and cooperating with said indexing module to insert the variable information into associated gaps to produce a customized content presentation;
whereby the customized content presentation includes the primary content presentation with the variable information filling the gaps.

2. The multimedia keepsake of claim 1, wherein:
the indexing module is in a control processor having access to the first information storage and containing programmed interrupts corresponding to the gaps;
the assembling module is in a playback processor having access to the second information storage, the content program being presented to the playback processor from the control processor, and
the control processor is constructed so that, when encountering an interrupt, it causes the playback processor to insert and playback the appropriate variable information.

3. The multimedia keepsake of claim 2 wherein the control processor and the playback processor are on a common circuit board.

4. The multimedia keepsake of claim 2 wherein the primary content presentation is an audio storybook and the variable information represents audible inserts for the storybook.

5. The multimedia keepsake of claim 4 wherein the playback processor is an audio synthesis processor synthesizing an audio signal from the fixed information and upon the occurrence of an interrupt, the processors cooperating to have the audio synthesis processor synthesize audio from the variable information.

6. The multimedia keepsake of claim 4 wherein the variable information is externally provided and the control processor is constructed to cause it to be stored in association with corresponding interrupts.

7. The multimedia keepsake of claim 6 further comprising a connection for one of an internet site, a kiosk and an electronic device through which the variable information may be received.

8. The multimedia keepsake of claim 2 wherein the playback processor is a synthesis processor synthesizing primary content presentation from the fixed information and upon the occurrence of an interrupt, the processors cooperating to have the synthesis processor synthesize content from the variable information.

9. The multimedia keepsake of claim 2 wherein the variable information is externally provided and the control processor is constructed to cause it to be stored in association with corresponding interrupts.

10. The multimedia keepsake of claim 9 further comprising a connection for one of an internet site, a kiosk and an electronic device through which the variable information may be received.

11. The keepsake in accordance with claim 1, further comprising:
an input receiving a two channel signal in which a first channel contains a signal representing the variable information and a second channel contains a tone of predetermined frequency which is encoded to identify the gap associated with information concurrently in the first channel;
a decoder for the encoding of the tone connected to the second channel, the decoder producing an address signal identifying the gap corresponding to the signal concurrently in the first channel;
a. connection for the first channel and the address signal to the indexing module, whereby it may control the storage of variable information in association with the corresponding gaps.

12. A method for providing a customized content presentation in a keepsake, comprising the steps of:
providing first information storage in the keepsake containing fixed information corresponding to a primary content presentation, the content presentation having gaps;
providing second information storage in the keepsake containing variable information; and
with a processor in the keepsake:
indexing the variable information in association with said gaps;
playing the fixed information from said first information storage and inserting the variable information into associated gaps on the basis of the indexing, to produce a customized content presentation;
whereby the customized content presentation includes the primary content presentation with the variable information filling the gaps.

13. The method of claim 12 wherein the primary content presentation is an audio storybook and the variable information represents audible inserts for the storybook.

14. The method of claim 12 wherein the variable information is externally provided.

15. The method of claim 14, further comprising the steps of:
receiving a two channel signal in which a first channel contains a signal representing the variable information and a second channel contains a tone of predetermined frequency which is encoded to identify the gap associated with information concurrently in the first channel;
decoding the second channel to extract an address signal identifying the gap corresponding to the signal concurrently in the first channel; and
utilizing the first channel signal and the address signal to store the variable information in association with corresponding gaps.

16. The method of claim 15 wherein the encoding lies in one of the duration of the tone and the sequence of the tones.

17. The method of claim 15 wherein the encoding lies in a modification made to the tone other than changing its frequency.

18. The method of claim 17 wherein the modification is a modulation of the tone.
